(19) United States
(12) Patent Application Publication
(10) Pub. No.: US 2005/0136962 A1
(43) Pub. Date: Jun. 23, 2005

(54) Component and composite signal level controller

(76) Inventors: William D. Woodward, JR., Lilburn, GA (US); William T. Murphy, Lawrenceville, GA (US); Glenn C. Howell, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/740,135

(22) Filed: Dec. 18, 2003

(51) Int. Cl. H04B 1/00; H04Q 7/20

(52) U.S. Cl. 455/522; 455/68; 455/69

(57) ABSTRACT

An apparatus in a subscriber television system receives a composite signal having a plurality of component signals carried therein. The apparatus receives user input and selectively controls the power levels of the component signals in the composite signal while selectively controlling the power level of the composite signal. The apparatus uses user input that specifies a specific component signal and a power level indicator and implements logic that adjusts the relative power levels of the component signals.

### FIELD OF THE INVENTION

This invention relates generally to broadband communications systems, such as subscriber television systems, and more specifically to controlling the power level of a component signal, which is carried in a composite signal, to optimize the signal to noise ratio of the composite signal.

### BACKGROUND OF THE INVENTION

In subscriber television networks, content such as television programming, Internet content, digital video programming and services, digital and non-digital audio programming and services are received at a headend and transmitted via a broadband distribution network to subscribers. Typically, in the U.S., subscriber television systems transmit both analog and digital signals downstream, from the headend to the subscriber, at frequencies ranging between 50 MHz and 870 MHz. For historical reasons, the radio frequency (RF) bandwidth for the analog and digital signals is 6 MHz. Thus, a subscriber transmitter system may transmit almost 140 signals from the headend 102 to the subscriber.

At the headend, a transmitter that employs a modulation scheme such as Quadrature Amplitude Modulation (QAM) frequently modulates the digital signals, and then, the modulated signals are combined into a composite signal. Typically, an operator manually adjusts the power levels of the modulated signals.

There exists a need for an apparatus and a method for optimally controlling the power levels of component signals, which are carried in a composite signal, while controlling the power level of the composite signal.

### BRIEF DESCRIPTION OF THE DRAWINGS

FIG. 1 is a block diagram of a broadband communications system, such as a cable television system, in which the preferred embodiment of the present invention may be employed.

FIG. 2 is a block diagram of a headend in the broadband communication system in which the preferred embodiment of the present invention may be employed.

FIG. 3 is a block diagram of an operator interface for a multi-modulator transmitter.

FIG. 4 is a block diagram of a multi-modulator transmitter.

FIGS. 5A-5B are a flow chart for logic implemented by a signal controller system.

### DETAILED DESCRIPTION OF A PREFERRED EMBODIMENT

Embodiments of the present invention will be described more fully hereinafter with reference to the accompanying drawings in which like numerals represent like elements throughout the several figures, and in which exemplary embodiments of the invention is shown. The present invention may, however, be embodied in many different forms and should not be construed as limited to the embodiments set forth herein. The examples set forth herein are non-limiting examples and are merely examples among other possible examples.

One way of understanding the preferred embodiments of the present invention includes viewing them within the context of a subscriber television system, which is a non-limiting example of a digital transmission network. However, the intended scope of the present invention includes all transmission networks. In one preferred embodiment, a multi-modulator transmitter transmits a composite signal, which includes multiple component signals, from a headend to a subscriber. The multi-modulator transmitter includes a signal controlling system that enables an operator to select a component signal and provide operator input for optimally controlling the power levels of the individual component signals while controlling the power level of the composite signal.

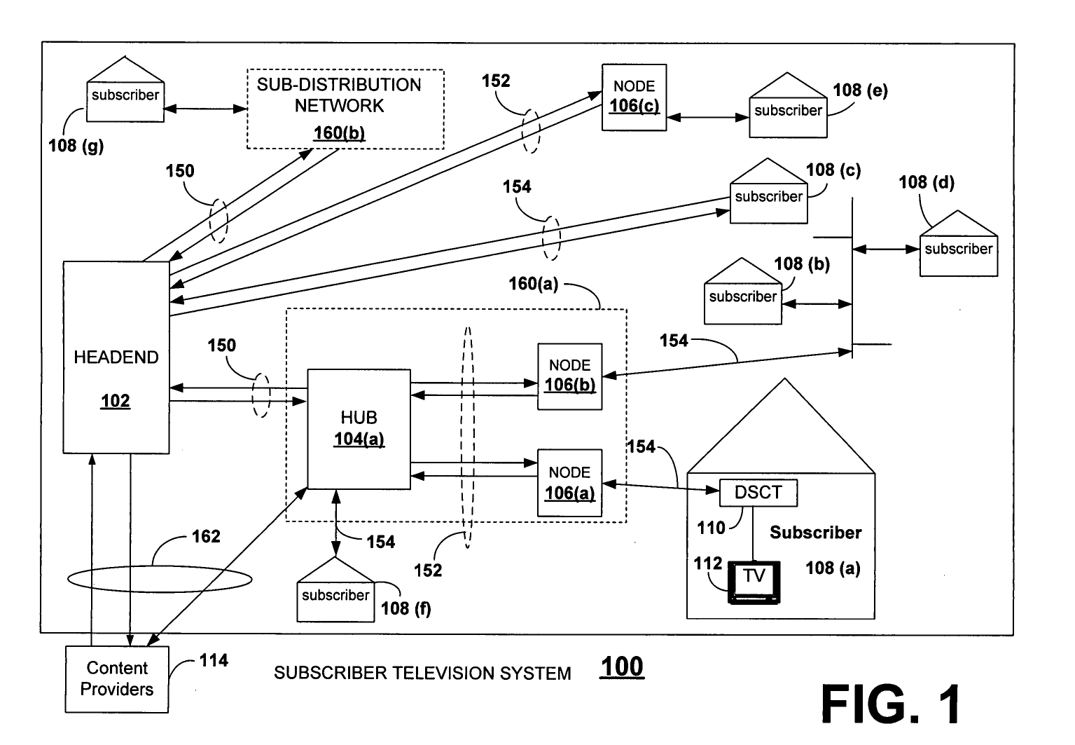

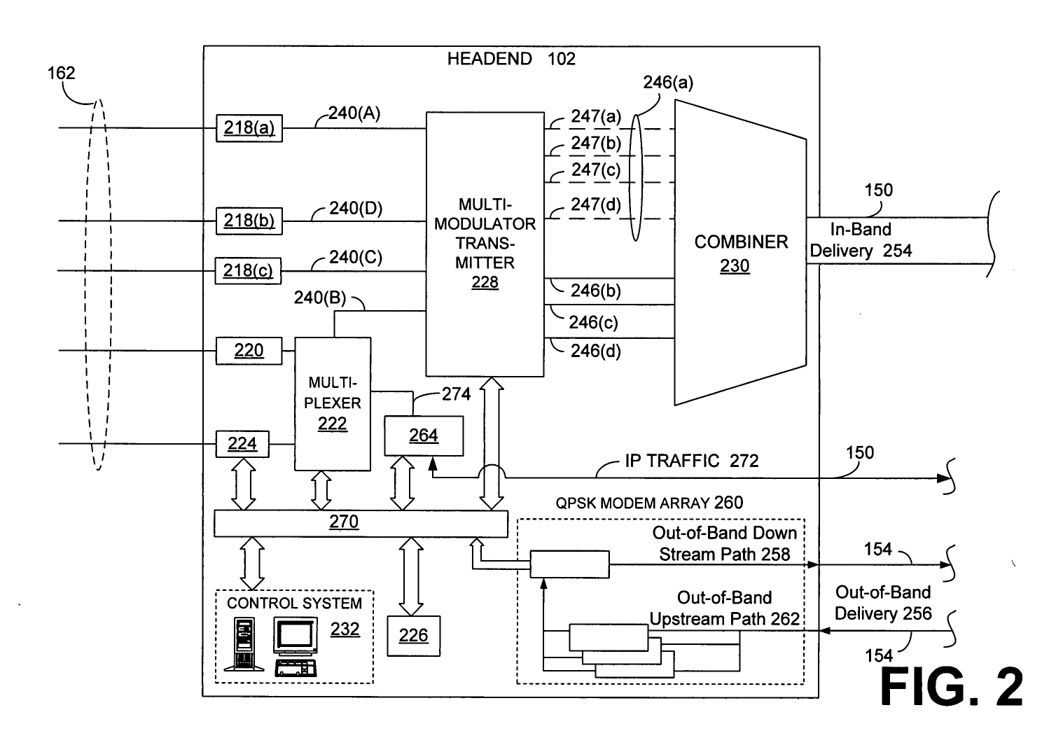

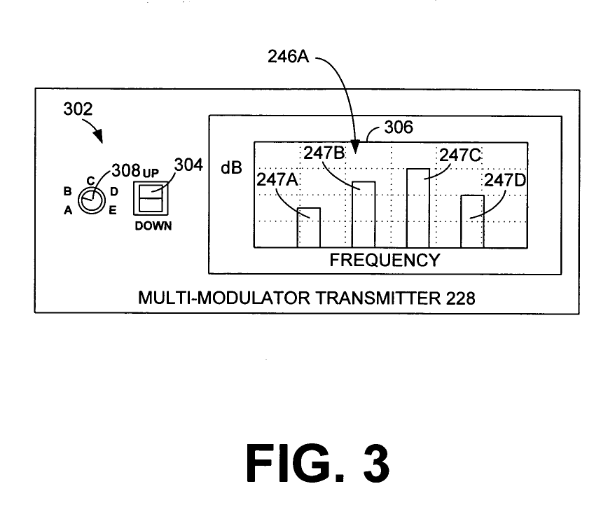

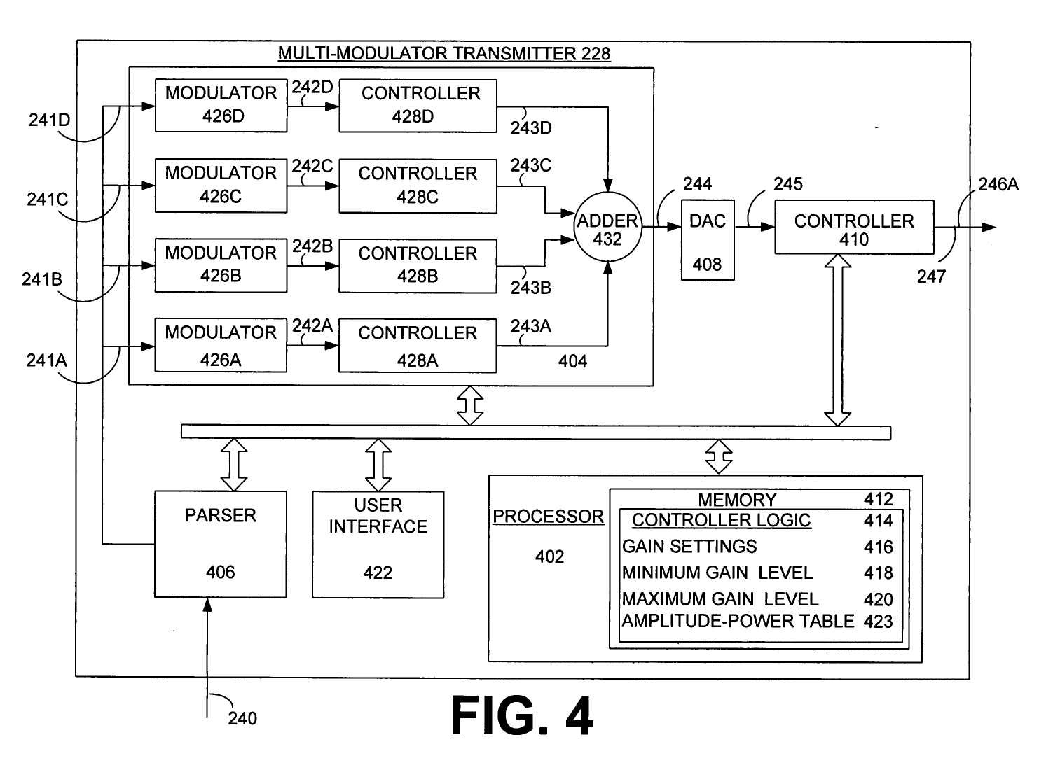

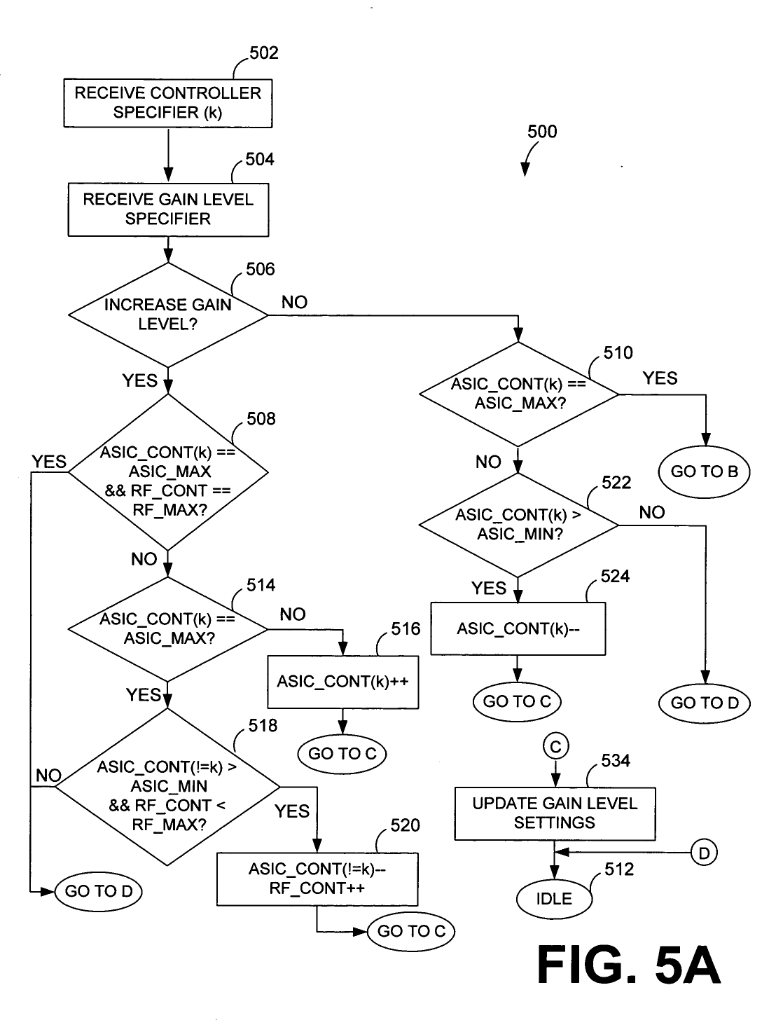

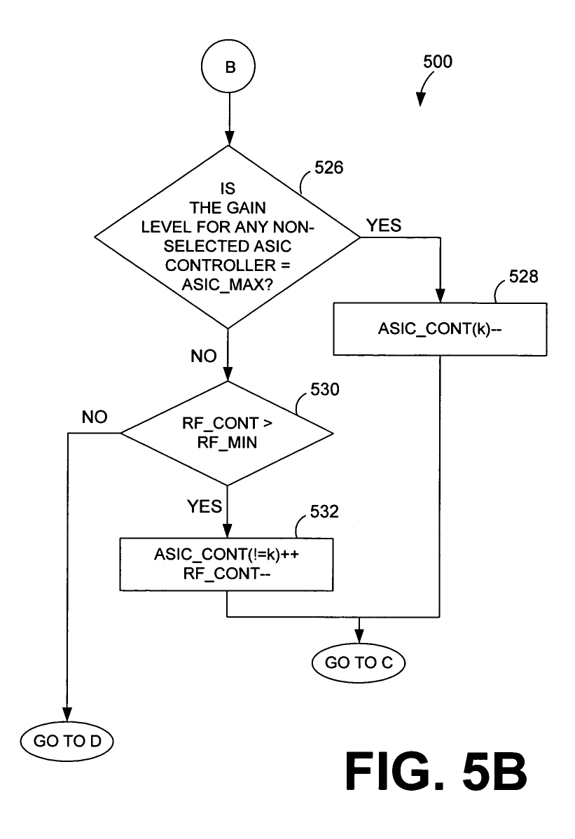

In the description that follows, FIGS. 1 and 2 will provide an example of system components that may be used in a subscriber television system. FIGS. 3 and 4 will provide an example of components for a signal controlling system implemented in a multi-modulator transmitter. Finally, FIGS. 5A-5C, 6A and 6B are illustrative flowcharts for implementing the logic of a signal controlling system. Note, however, that the invention may be embodied in many different forms and should not be construed as limited to the embodiments set forth herein. Furthermore, all examples given herein are intended to be non-limiting and are provided in order to help convey the scope of the invention.

It should be understood that the logic of the preferred embodiment(s) of the present invention could be implemented in hardware, software, firmware, or a combination thereof. In one preferred embodiment(s), the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present invention includes embodying the functionality of the preferred embodiments of the present invention in logic embodied in hardware or software-configured mediums.

Furthermore, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, the process descriptions or blocks in flow charts should be understood as representing decisions made by a hardware structure such as a state machine known to those skilled in the art.

Television System Overview

Referring to FIG. 1, a subscriber television system (STS) 100 includes, in one example among others, a headend 102, a plurality of hubs 104, multiple nodes 106, a plurality of subscriber locations 108, and a plurality of digital subscriber communication terminals (DSCTs) 110. The headend 102 provides the interface between the STS 100 and content and service providers 114, such as broadcasters, internet service providers, and the like via communication link 162. The communication link 162 between the headend 102 and the content and service providers 114 is generally two-way, thereby allowing for interactive services such as Internet access via STS 100, video-on-demand, interactive program guides, etc. In one preferred embodiment, the hubs 104 are in direct two-way communication with the content and service providers 114 via communication link 162.

In one preferred embodiment, the headend 102 is in direct communication with the hubs 104 via communication link 150 and in direct or indirect communication with the nodes 106 and subscriber locations 108. For example, the headend 102 is in direct communication with node 106(c) via a communication link 152 and in indirect communication with nodes 106(a) and 106(b) via hub 104. Similarly, the headend 102 is in direct communication with subscriber location 108(c) via communication link 154 and in indirect communication with subscriber location 108(a) via hub 104.

The hub 104 receives programming and other information (typically in an Ethernet format) from headend 102 via communication link 150 and transmits information and programming via communication link 152 to nodes 106, which then transmit the information to subscriber locations 108 through communication link 154. Again, whether the hub 104 communicates directly to subscriber locations 108 or to nodes 106 is matter of implementation, and in one preferred embodiment, the hub 104 is also adapted to transmit information and programming directly to subscriber locations 108 via communication link 154.

In one preferred embodiment, the communication link 150 and 152 are transmission media such as optical fibers that allow the distribution of high quality and high-speed signals, and the communication link 154 is a transmission medium such as either broadband coaxial cable or optical fiber. In alternative embodiments, the transmission media 150, 152 and 154 can incorporate one or more of a variety of media, such as optical fiber, coaxial cable, and hybrid fiber-coax (HFC), satellite, over the air optics, wireless RF, or other transmission media known to those skilled in the art. Typically, the transmission media 150, 152 and 154 are two-way communication media through which both in-band and out-of-band information are transmitted. Through the transmission media 150, 152 and 154 subscriber locations 108 are in direct or indirect two-way communication with the headend 102 and/or the hub 104.

The hub 104 functions as a mini-headend for the introduction of programming and services to sub-distribution network 160. The sub-distribution network 160(a) includes a hub 104(a) and a plurality of nodes 106(a) and 106(b) connected to hub 104(a). Having the STS 100 divided into multiple sub-distribution networks 160 facilitates the introduction of different programming, data and services to different sub-distribution networks 160 because each hub 104 functions as a mini-headend for providing programming, data and services to DSCTs 110 within its sub-distribution network 160. For example, the subscriber location 108(b), which is connected to node 106(b), can have different services, data and programming available than the services, data and programming available to subscriber location 108(c), which is connected directly to headend 102, even though the subscriber locations 108(b) and 108(c) may be in close physical proximity to each other. Services, data and programming for subscriber location 108(b) are routed through hub 104(a) and node 106(b); and hub 104(a) can introduce services, data and programming into the STS 100 that are not available through the headend 102.

At the subscriber locations 108 a decoder or a DSCT 110 provides the two-way interface between the STS 100 and the subscriber. The DSCT 110 decodes and further process the signals for display on a display device, such as a television set (TV) 112 or a computer monitor, among other examples. Those skilled in the art will appreciate that in alternative embodiments the equipment for decoding and further processing the signal can be located in a variety of equipment, including, but not limited to, a DSCT, a computer, a TV, a monitor, or an MPEG decoder, among others.

Headend

Referring to FIG. 2, in a typical system that includes one preferred embodiment of the invention, the headend 102 receives content from a variety of input sources, which can include, but are not limited to, a direct feed source (not shown), a video camera (not shown), an application server (not shown), and other input sources (not shown). The input signals are transmitted from the content providers 114 to the headend 102 via a variety of communication links 162, which include, but are not limited to, satellites (not shown), terrestrial broadcast transmitters (not shown) and antennas (not shown), and direct lines (not shown). The signals provided by the content providers 114 can include a single program or a multiplex that includes several programs, and typically, some of the content from the input sources is encrypted.

The headend 102 generally includes a plurality of receivers 218 that are each associated with a content source. Generally, the content is transmitted from the receivers 218 in the form of transport stream 240. MPEG encoders, such as encoder 220, are included for digitally encoding content such as local programming or a feed from a video camera. Typically, the encoder 220 produces a variable bit rate transport stream. Prior to being modulated, some of the signals may require additional processing, such as signal multiplexing, which is preformed by multiplexer 222.

A switch, such as asynchronous transfer mode (ATM) switch 224, provides an interface to an application server (not shown). There can be multiple application servers providing a variety of services such as, among others, a data service, an Internet service, a network system, or a telephone system. Service and content providers 114 (shown in FIG. 1) may download content to an application server located within the STS 100 or in communication with STS 100. The application server may be located within headend 102 or elsewhere within STS 100, such as in a hub 104.

Typically, the headend 102 includes a server such as a video-on-demand (VOD) pump 226. VOD pump 226 provides video and audio programming such as VOD pay-per-view programming to subscribers of the STS 100. In response to a subscriber's request, the VOD pump 226 sends a stream of network packets having content for a subscriber selected program to a router 264 via communication link 270. The router 264 then sends the received network packets to the multiplexer 222 via communication link 274 and the multiplexer 222 multiplexes the network packets into the transport stream 240B.

The various inputs into the headend 102 are then combined with the other information, which is specific to the STS 100, such as local programming and control information. The headend 102 includes a multi-modulator transmitter 228 that receives a plurality of transport streams 240 and transmits a plurality of modulated composite signals 246A-246D, and each of the composite signals 246 include multiple component signals 247. For the sake of clarity the component signals 247A-247D are represented by four separate dashed lines, but the component signals 247A-247D are carried in the composite signal 246A in a single communication medium.

In one preferred embodiment, the composite signals 246 from the multi-modulator transmitter 228 are combined, using equipment such as a combiner 230, for input into the communication link 150, and the combined signals are sent via the in-band delivery path 254 to subscriber locations 108.

The transport streams 240A-240D received by the multi-modulator transmitter 228 include programs, or sessions, from different sources, which are multiplexed together into output transport streams, and the multi-modulator transmitter 228 also multiplexes information related to the decryption of encrypted information into the output transport streams. Typically, each one of the output transport streams are radio frequency modulated at a set frequency and transmitted as component signals 247 carried in the composite signal 246.

For the DSCT 110 (shown in FIG. 1) to receive a television program, in one preferred embodiment, among others, the DSCT 110 tunes to the frequency associated with the modulated transport stream that contains the desired information, de-multiplexes the transport stream, and decodes the appropriate program streams. The system is not limited to modulated transmission. Baseband transmission may also be used, in which case the multi-modulator 228 does not have a modulator but includes other components such as an output multiplexer and baseband electrical or optical interface.

A system controller, such as control system 232, which preferably includes computer hardware and software providing the functions discussed herein, allows the STS operator to control and monitor the functions and performance of the STS 100. The control system 232 interfaces with various components, via communication link 270, in order to monitor and/or control a variety of functions, including the channel lineup of the programming for the STS 100, billing for each subscriber, and conditional access for the content distributed to subscribers. Control system 232 provides input to the multi-modulator transmitter 228 for setting their operating parameters, such as system specific MPEG table packet organization and conditional access information.

Control information and other data or application content can be communicated to DSCTs 110 via the in-band delivery path 254 or to DSCTs 110 connected to the headend 102 via an out-of-band delivery path 256 of communication link 154. Data is transmitted via the out-of-band downstream path 258 of communication link 154 by means such as, but not limited to, a Quadrature Phase-Shift Keying (QPSK) modem array 260, or an array of data-over-cable service interface specification (DOCSIS) modems, or other means known to those skilled in the art.

Out-of-band delivery path 256 of communication link 154 also includes upstream path 262 for two-way communication between the headend 102 and the DSCTs 110. DSCTs 110 transmit out-of-band data through the communication link 154, and the out-of-band data is received in headend 102 via out-of-band upstream paths 262. The out-of-band data is routed through the router 264 to an application server or to the VOD pump 226 or to control system 232. Out-of-band data includes, among other things, control information such as a pay-per-view purchase instruction and a pause viewing command from the subscriber location 108 (shown in FIG. 1) to a video-on-demand type application server, and other commands for establishing and controlling sessions, such as a Personal Television session, etc. The QPSK modem array 260 is also coupled to communication link 152 (FIG. 1) for two-way communication with the DSCTs 110 coupled to nodes 106.

Among other things, the router 264 is used for communicating with the hub 104 through communication link 150. Typically, command and control information, among other information, between the headend 102 and the hub 104 are communicated through communication link 150 using a protocol such as, but not limited to, Internet Protocol. The IP traffic 272 between the headend 102 and hub 104 can include information to and from DSCTs 110 that connect to hub 104.

The control system 232, such as Scientific-Atlanta's Digital Network Control System (DNCS), as one acceptable example among others, also monitors, controls, and coordinates all communications in the subscriber television system, including video, audio, and data. The control system 232 can be located at headend 102 or remotely.

In one preferred embodiment, the multi-modulator transmitter 228 is adapted to encrypt content prior to modulating and transmitting the content. Typically, the content is encrypted using a cryptographic algorithm such as the Data Encryption Standard (DES) or triple DES (3DES), Digital Video Broadcasting (DVB) Common Scrambling or other cryptographic algorithms or techniques known to those skilled in the art. The multi-modulator transmitter 228 receives instructions from the control system 232 regarding the processing of programs included in the input transport streams 240. Sometimes the input transport streams 240 include programs that are not transmitted downstream, and in that case, the control system 232 instructs the multi-modulator transmitter 228 to filter out those programs. Based upon the instructions received from the control system 232, the multi-modulator transmitter 228 encrypts some or all of the programs included in the input transport streams 240 and includes the encrypted programs in the component signals 247. Some of the programs included in input transport stream 240 do not need to be encrypted, and in that case the control system 232 instructs the multi-modulator transmitter 228 to transmit those programs without encryption. The multi-modulator transmitter 228 sends the DSCTs 110 the keys that are needed to decrypt encrypted programs. It is to be understood that for the purposes of this disclosure a “program” extends beyond a conventional television program and that it includes video, audio, video-audio programming and other forms of services and service instances and digitized content. “Entitled” DSCTs 110 are allowed to use the keys to decrypt encrypted content, details of, which are provided hereinbelow.

In one preferred embodiment, the hub 104, which functions as a mini-headend, includes many or all of the same components as the headend 102. The hub 104 is adapted to receive, among other signals, the composite signals 246 included in the in-band path 254 and distribute the content therein throughout its sub-distribution network 160. The hub 104 includes a QPSK modem array (not shown) that is coupled to communication links 152 and 154 for two-way communication with DSCTs 110 that are coupled to its sub-distribution network 160. Thus, the hub 104 is adapted to communicate with the DSCTs 110 that are within its sub-distribution network 160, with the headend 102, and with the content providers 114. In one preferred embodiment, the hub 104 is adapted to communicate with the DSCTs 110 that are within its sub-distribution network 160 and with the headend 102. Communication between the hub 104 and content providers 114 is transmitted through the headend 102.

Multi-Modulator Transmitter

Referring to FIG. 3, the multi-modulator transmitter 228 includes a signal selector 302, a power level adjuster 304, and a signal display 306. The signal display 306 displays the power level as a function of frequency of the composite signal 246. Composite signal 246 is comprised of component signals 247A-247D. Each one of the component signals 247A-247D is centered on a different frequency and their frequency bands are 6 megahertz in width and do not overlap.

The signal selector 302 has a dial 308 that can be set to settings A-E. Each one of the settings from A-D corresponds to one of the component signals 247A-247D, respectively. The setting E is used to select all of the component signals together.

An operator adjusts the power level of a component signal 247 by first setting the dial 308 to select the desired component signal, and then using the power level adjuster 304 to raise or lower the relative power level of the selected component signal 247. In the preferred embodiment, the relative power level between the selected component signal and the other component signals is changed by 0.1 dB each time the operator presses the power level adjuster 304 upward/downward, until the power level of the selected signal has reached a predetermined maximum/minimum value. After the power level of the selected component signal is at its maximum/minimum value, the relative power level of the selected component signal is not changed by the operator inputting power level changes with the power level adjuster 304. The operator uses the signal display 306 to monitor the changes in the power levels of the component signals 247A-247D.

With the signal selector 302 set to “E,” the operator can use the power level adjuster 304 to increase/decrease the absolute power level of all of the component signals in the composite signal 246, and each one of the component signals 247 is scaled by approximately the same amount. In an alternative embodiment, the signal selector 302 includes settings for only the component signals 247, and if the operator wants to change the power level of all of the component signals in the composite signal 246 the operator adjusts each one individually using settings A-D.

Referring to FIG. 4, the multi-modulator transmitter 228 includes a processor 402, an modulator block 404, a parser 406, a digital-to-analog converter 408, a composite signal gain controller 410, and an operator interface 422. The operator interface includes the signal selector 302, the power level adjuster 304 and the signal display 306, shown in FIG. 3.

The processor 402 includes a memory 412, which includes power level controller logic 414 and initialization values (not shown). The power level controller logic 414 includes gain settings 416, and predetermined minimum and maximum gain settings 418 and 420, respectively. The processor 402 receives operator input via the operator interface 422 and uses the operator input along with the power level controller logic 414 to control the power level of the component signals 247A-247D and the power level of the composite signal 246 transmitted from the composite signal gain controller 410.

The parser 406 receives the transport streams 240 and uses system information from the processor 402 to demultiplex the received transport streams 240 into transport streams 241A-241D, which are provided to the modulator block 404.

The modulator block 404 includes multiple modulators 426A-426D, a corresponding number of component signal gain controllers 428A-428D, and a signal adder 432. In one preferred embodiment, the modulator block 404 is an ASIC. In another embodiment, each of the modulators 426 is included in separate electronic circuitry or each modulator 426 and signal gain controller 428 pair is included in separate electronic circuitry. In addition, those skilled in the art will recognize that a processor, a FPGA, a DSP chip or other such device can embody the modulator block 404.

The modulator block 404 is embodied in an ASIC for economic reasons. It is more cost effective to have a single ASIC with multiple pairs of modulators 426A-426D and component signal gain controllers 428A-428D than to have multiple separate modulators 426 and signal gain controllers 428 pairs. In addition, it is frequently desirable to make components of the headend 102 and the hubs 104 small because of limited physical space in the headend 102 and hubs 104. By having all of the multiple modulators 426 and signal gain controllers 428 pairs on an ASIC, instead of having multiple separate modulator/signal level controller pairs, the size of the multi-modulator transmitter 228 is generally reduced.

In one preferred embodiment, the modulators 426A-426D are quadrature amplitude modulators (QAM). However, it should be understood that modulators 426 include but are not limited to, devices for outputting a signal such as QPSK, QPR, and other digital modulation formats known to those skilled in the art. Each one of the modulators 426 transmits a component signal 242 at a given frequency, which is different from the frequency of any other modulator 426.

The component signal gain controllers 428 and the composite signal gain controller 410 are essentially functionally identical. They receive and transmit signals, and they control the power levels of the signal that they transmit. The signal gain controllers 428 and 410 are controlled by the processor 402, which determines an optimal power level for the transmitted signals. The gain of a signal is simply the ratio of the output signal over input signal. In an alternative embodiment, the processor 402 controls the signal gain controllers 428 and 410 based upon their output power levels.

The component signal gain controllers 428A-428D receive the component signals 242A-242D from the modulators 426 and transmit component signals 243A-243D, respectively, to the adder 432. In one preferred embodiment, the signal gain controllers are signal multipliers with a predetermined base value. The processor 402 sends a gain setting to the signal gain controller. The signal gain controller generates a scaling factor, which is the ratio of a gain setting to a base factor, and uses the scaling factor for controlling the power level of the transmitted signal. When the scaling factor is less than one, the power level of the transmitted signal is attenuated, and the power level of the transmitted signal is amplified when the scaling factor is greater than one. In the preferred embodiment, the signal gain controllers control the power level of their transmitted signals 243 and 246 by scaling the amplitude of their received signals 242 and 245, respectively.

The adder 432 adds the received component signals 243A-243D and transmits a composite signal 244, which includes each one of the component signals 243A-243D, to the DAC 408. The DAC 408 converts the composite signal 244 from a digital format to an analog format and outputs an analog composite signal 245. It is preferable that the power level of the composite signal 244 be as high as possible while remaining in the dynamic range of the DAC 408.

The composite signal gain controller 410 receives the analog composite signal 245 from the DAC 408 and outputs the composite signal 246. The composite signal gain controller 410 controls the power level of the composite signal 246. In one embodiment, the composite signal gain controller is included in a radio frequency (RF) converter that converts intermediate frequency to the composite signal 246 to a full range of frequencies suitable for downstream transmission in a cable television environment.

Generally, the signal to noise ratio of the composite signal 246 is optimized by controlling the power levels of the component signals 243 so that they are as high as possible. However, if the power level of the composite signal 244 is outside of the dynamic range of the DAC 408, the output composite signal 245 will be clipped. Thus, in the preferred embodiment, the processor 402 selectively adjusts the power levels of the component signals 243 using the power level controller logic 414 and operator input to optimize the power levels of the component signals 243 and to control the power levels of the component signals 247 in the composite signal 246.

The power level controller logic 414 uses the gain settings 416 of the component signal gain controllers 428A-428D and of the composite signal gain controller 410 and the predetermined minimum and maximum gain settings 418 and 420, respectively, for optimally changing the absolute or relative power level of the operator selected signal. The minimum and maximum gain settings 418 and 420, respectively, can be the same or different for the component signal gain controllers 428 and the composite signal gain controller 410, and furthermore, each of the component signal gain controllers 428 can have different minimum and maximum power level settings 418 and 420, respectively. In one preferred embodiment, the power level controller logic 414 will keep the minimum and maximum power level settings for each of the component signal level controllers 428 approximately equal since it is generally desirable to have the power level of each of the component signals 243 approximately equal.

In one preferred embodiment, the controller logic 414 keeps the peak amplitude of the composite signal 244 as close as possible to a predetermined value, DAC_MAX, which is typically the maximum amplitude of the signal that the DAC 408 can receive. If the amplitude of the composite signal 244 is greater than DAC_MAX, then the output composite signal 245 is clipped by the DAC 408. In this embodiment, the gain controllers 428 and 410 each receive an amplitude multiplying factor from the processor 402. Each of the gain controllers 428 (410) scale the amplitude of their respective input signal 242 (245) by multiplying the amplitude by a scaling factor, which is the amplitude multiplying factor divided by a base factor.

The processor 402 retains in memory 412 the current amplitude multiplying factors for each of the gain controllers 428 and 410. An amplitude-power table 423 is also stored in the memory 412, and the amplitude-power table 423 relates amplitude multiplying factors to changes in power levels, which are measured in 0.1 decibels (dB). When the operator selects a signal to adjust and inputs a change in the power level of the selected signal via the power level adjuster 304, the processor 402 uses the amplitude-power table 423 and controller logic 414 to determine a new amplitude multiplying factor for the selected gain controller 428 (410). Instead of merely incrementing or decrementing the old amplitude multiplying factor, the processor 402 uses the amplitude-power table 423 to determine the correct amplitude multiplying factor needed in order to produce the new power level. The relationship between signal power level measured in dB and the amplitude multiplying factor is non-linear, which is why the processor uses the amplitude-power table 423 instead of simply incrementing or decrementing the amplitude multiplying factor.

Upon initialization, the processor 402 reads from memory 412 initialization output power level values for each component signal 247A-247D, and implements the controller logic 414 to set the gain of each component signal gain controller 428 such that the amplitude of the composite signal 244 is as close as possible to the DAC_MAX amplitude, and processor 402 controls the gain of the composite signal gain controller 410 such that signal 247A-247D in the composite signal 246 is at a power level that corresponds to it's initialization power level value stored in the memory 412.

Responsive to the operator incrementing the power level, the controller logic 414 selectively controls amplitude multiplying factors of component signals 243A-243D and the composite signal 246 so that it can raise the relative power level of a selected component signal. In other words, the processor 402 can determine whether to: (1) raise the gain of the selected component signal gain controller 428, or (2) lower the gain of the non-selected component signal gain controllers 428 and raise the gain of the composite signal gain controller 410.

For example, responsive to the operator incrementing the power level of signal 247A, the processor 402 determines from memory 412 the current amplitude multiplying factors for each of the component signals 243A-243D. If the current amplitude multiplying factor for signal 243A is not a maximum value, the processor 402 uses the amplitude power table to determine a new amplitude multiplying factor for the gain controller 428A and calculates the sum of the amplitude multiplying factors for component signals 243A-243D using the new amplitude multiplying factor for signal 243A in the summation. If the sum of the amplitude multiplying factors is less than the DAC_MAX amplitude, then the processor 402 replaces the current amplitude multiplying factor in memory 412 with the new one. To the operator, who is measuring the relative power levels of the component signals 247A-247D in the composite signal 246, it appears that the component signal 247A has increased while the other signals remained the same.

However, if either the current amplitude multiplying factor for signal 243A is a maximum value or if increasing the current amplitude multiplying factor for signal 243A causes the sum of the amplitude multiplying factors to be greater than the DAC_MAX amplitude, then the amplitude multiplying factor for signal 243A could not be raised. In this case, the processor 402 would attempt to lower the amplitude multiplying factor for each of the component signals 243B-243D and raise the amplitude multiplying factor for the composite signal 246. Again, the net effect, as viewed by the operator, is to raise the relative power level of the selected component signal 247A in the composite signal 246. Whereas, in actuality, the absolute amplitudes of each of the component signals 243B-243D, as measured between their respective signal controllers 428 and the adder 432, have been decreased, and the gain through composite signal gain controller 410 has been increased to compensate for the decrease in the amplitude of the component signals 243B-243D. Typically, it is desirable that the relative power levels of the component signal 243 be within a predetermined range of each other, and in that case, the processor 402 does not increase or decrease the amplitude multiplying factor for a single component signal 243 nor increase or decrease the amplitude multiplying factor for all but one component signal if doing so would result in the relative power levels of the component signals not being in the predetermined range of each other.

In addition to being able to raise the relative power level of a selected composite signal, the controller logic 414 is similarly adapted to selectively control amplitude multiplying factors of component signals 243A-243D and the composite signal 246 so that it can lower the relative power level of a selected component signal. In other words, the processor 402 can determine whether to: (1) lower the amplitude multiplying factor for the selected component signal gain controller 428, or (2) raise the amplitude multiplying factors for the non-selected component signal gain controllers 428 and lower the amplitude multiplying factor for the composite signal gain controller 410.

FIGS. 5A-5B illustrates an exemplary embodiment of the steps performed by the power level logic 414. It is to be understood that this is merely a non-limiting exemplary embodiment and that other embodiments of the power level controller logic 414 are intended to be within the scope of the invention. In steps 500, which are illustrated in FIGS. 5A-5B, the following terminology is used: “ASIC_CONT(k)” refers to an operator selected component signal gain controller 428; “ASIC_CONT(!=k)” refers to all of the component signal gain controllers 428 except for the selected component signal gain controller; and “RF_CONT” refers to the composite signal gain controller 410.

Referring to FIG. 5A, in step 502, the processor 402 receives a controller specifier (k) from the signal selector 302. The controller specifier (k) identifies a specific component signal gain controller 428 of the component signal gain controllers 428 or the composite signal gain controller 410 as the signal level controller selected by the operator.

In step 504, the processor 402 receives a power level specifier from the power level adjuster 304. The power level specifier indicates whether the power level for the signal transmitted from the selected signal level controller should be increased or decreased.

In step 506, the processor 402 determines whether the power level specifier indicates an increase or decrease in the power level of the selected signal. When the power level specifier indicates an increase, then the processor 402 proceeds to step 508, otherwise it proceeds to step 510.

In step 508, the processor 402 determines two conditions: (1) whether the gain setting 416 for the selected component signal gain controller 428 is equal to its predetermined maximum 420; and (2) whether the gain setting 416 for the composite signal gain controller 410 is equal to its predetermined maximum 420. If both conditions are met, then the power level of the selected signal cannot be increased and the processor 402 drops to step 512, where the processor 402 awaits further input from the operator while performing other functions. On the other hand, when both conditions are not met, the processor 402 proceeds to step 514.

In step 514, the processor 402 checks the memory 412 to determine whether the gain setting 416 for the selected component signal gain controller 428 is equal to its predetermined maximum 420. In an alternative embodiment, instead of storing the gain settings 416 of the gain controllers 428 and 410 in memory 412, the processor 402 determines the gain settings by querying the gain controllers. When the gain setting 416 is not equal to the predetermined maximum setting 420, then the processor 402 proceeds to 516 and increases the gain setting 416 for the selected component signal gain controller 428.

However, when the gain setting 416 of the selected component signal gain controller 428 is already equal to its predetermined maximum setting 420 and cannot be further increased, the processor 402 proceeds to step 518. Even though the absolute power level of the selected signal cannot be increased, it may still be possible to increase the relative power level of the selected component signal. Decreasing the gain settings 416 for the non-selected component signal gain controllers 428 and increasing the gain setting 416 for the composite signal gain controller 410 has the desired effect of raising the relative power level of the selected component signal. For each of the non-selected component signal gain controllers 428, the processor 402 determines whether the gain setting 416 is above its predetermined minimum value setting 418 and whether the gain setting 416 for the composite signal gain controller 410 is beneath its predetermined maximum gain setting 420. Only when all of the non-selected component signal gain controllers 428 can have their gain settings 416 decreased and the composite signal gain controller 410 can have its gain setting 416 increased does the processor 402 proceed to step 520, otherwise, the processor proceeds to step 512.

When either or both conditions of step 518 are not met, then the relative power level of the selected signal cannot be changed in the desired fashion and the processor 402 proceeds to 512 and awaits further operator input. On the other hand, when both conditions are met, the processor 402 proceeds to step 520 and decreases the gain setting 416 for each of the non-selected component signal gain controllers 428 and raises the gain setting 416 for the composite signal gain controller 410.

Referring back to step 506, when the operator selects a component signal and indicates a decrease in the relative power, the processor 402 proceeds to step 510 and determines whether the gain setting 416 for the selected component signal gain controller 428 is equal to its maximum gain setting 420. If the gain setting 416 is not equal to the maximum gain setting 420, then the processor 402 proceeds to step 522 and determines whether the gain setting 416 for the selected component signal gain controller 428 is greater than the minimum power level setting 418.

In step 524, the processor 402 decrements the gain setting 416 for the selected component signal gain controller 428. Step 524 is performed only when the condition of step 522 is positive. Consequently, the gain setting 416 is never decremented to a value beneath the minimum gain setting 418.

On the other hand, when the condition of step 522 is not met, the processor 402 proceeds to step 512 and awaits further operator input.

Referring back to step 510, when the gain setting 416 for the selected component signal gain controller 428 is equal to the maximum gain setting 420, the processor proceeds to step 526 (see FIG. 5B). Typically, it is desirable to keep the power level of the component signals 243 as high as possible for optimal signal-to-noise performance. Therefore, instead of just decrementing the gain setting 416 for the selected signal level controller 428, the processor 402 first determines whether the gain setting 416 for any of the non-selected component signal gain controllers 428 is equal to its maximum gain setting 420. If so, the processor 402 proceeds to step 528 and decrements the gain setting 416 for the selected component signal gain controller 428. In step 528, the processor 402 decrements the gain setting 416 of the selected component signal gain controller 428 because the power level setting of at least one of the non-selected component cannot be raised.

However, when none of the non-selected component signal gain controllers 428 have a gain setting 416 equal to the maximum gain setting 420, the processor 402 proceeds to step 530 and determines if the gain setting 420 for the composite signal gain controller 410 is greater than the minimum gain setting 418. If so, the processor 402 proceeds to step 532 and increments the gain setting 416 for each of the non-selected component signal gain controllers 428 and decrements the gain setting 416 for the composite signal gain controller 410. The net effect of step 532 is to decrease the relative power level between the selected component signal and the other component signals and to keep the power level of the composite signal approximately constant. On the other hand, when the condition of step 530 is negative, the processor 402 proceeds to step 512 and awaits further operator input.

Referring to FIGS. 5A-5B, in steps 516, 520, 524, 528, and 532 at least one gain setting 416 was changed, either decremented or incremented. After the processor 402 has determined to change one or more of the gain settings 416, then in step 534 (see FIG. 5A), the processor 402 stores the gain settings in memory 412 and signals the affected signal gain controllers of the change. For example, in step 516, the selected component signal gain controller 428 is signaled to increase the power level of the component signal 243 transmitted therefrom. The net effect of steps 516 and 520 is to increase the power level of the selected component signal relative to the other (non-selected) component signals in the composite signal 246; where step 516 is used if the selected component signal gain controller 428 is currently below the maximum gain level 420 and step 520 is used if the selected component signal gain controller 428 is currently equal to the maximum gain level 420. The net effect of steps 524, 528, and 532 is to decrease the power level of the selected component signal relative to the other (non-selected) component signals in the composite signal 246; where steps 524 and 528 are used if any of the non-selected component signal gain controllers 428 are currently equal to the maximum gain level 420 and step 532 is used if none of the non-selected component signal gain controllers 428 are currently equal to the maximum gain level 420.

Although exemplary preferred embodiments of the present invention have been shown and described, it will be apparent to those of ordinary skill in the art that a number of changes, modifications, or alterations to the invention as described may be made, none of which depart from the spirit of the present invention. Changes, modifications, and alterations should therefore be seen as within the scope of the present invention. It should also be emphasized that the above-described embodiments of the present invention, particularly, any “preferred embodiments” are merely possible non-limiting examples of implementations, merely setting forth a clear understanding of the principles of the inventions.

1. A signal controller for an apparatus that receives a plurality of input signals and transmits a composite signal therefrom, the signal controller comprising:
a memory having signal controller logic stored therein; and
a processor in communication with the memory adapted to use the signal controller logic to selectively control the peak power level of a composite signal having a plurality of component signals carried therein.

2. The signal controller of claim 1, wherein the processor selectively controls the peak power levels of the component signals such that the peak power level of the composite signal carrying the plurality of component signals therein beneath a predetermined maximum power level.

3. The signal controller of claim 1, wherein responsive to operator input indicating an increase in power of a particular component signal, the processor decreases the peak power levels of the component signals that are not the particular component signal and increases the gain of the composite signal.

4. The signal controller of claim 1, wherein responsive to operator input indicating a decrease in power of a particular component signal, the processor increases the peak power levels of the component signals that are not the particular component signal and decreases the gain of the composite signal.

5. The signal controller of claim 1, further including:
an operator interface in communication with the processor adapted to receive user input including a power level indicator that indicates an increase or decrease in the relative power between a specific component signal and the other component signals of the composite signal, wherein responsive to the power level indicator indicating either an increase or decrease, the processor determines whether to increase the peak power level of at least one component signal.

6. The signal controller of claim 1, further including:
a plurality of component signal gain controllers in communication with the processor, each component signal gain controller adapted to control one of the component signals therefrom at a peak power level specified by the processor; and
a component signal adder in communication with the plurality of component signal gain controllers, the component signal adder adapted to receive the plurality of component signals, add the plurality of component signals into the composite signal and transmit the composite signal therefrom.

7. The signal controller of claim 6, further including:
a composite signal gain controller in communication with the processor adapted to receive the composite signal from the signal adder and controllably transmit the composite signal therefrom, wherein the processor receives a signal specifier that is associated with a specific component signal of the component signals transmitted from a specific component signal gain controller and a gain level indicator that indicates an increase or decrease in the relative power level of the specific component signal.

8. The signal controller of claim 7, wherein the processor determines whether the peak power level the composite signal transmitted from the signal adder is less than a predetermined first maximum, and when the composite signal is less than the first maximum and the gain level indicator indicates an increase in relative power, the processor signals the specific component signal gain controller to increase the gain of the specific component signal transmitted therefrom, and when the peak power level of the composite signal is greater than or equal to the first maximum and the gain level indicator indicates an increase in relative power, the processor signals each one of the component signal gain controllers that is not the specific component signal gain controller to decrease the gain of the component signal transmitted therefrom.

9. The signal controller of claim 8, wherein the processor only signals the specific component signal gain controller to increase the gain level when the peak power level of the specific component signal is less than a second predetermined maximum.

10. The signal controller of claim 8, wherein only when the gain level of each component signal transmitted from the signal gain controllers that are not the specific signal gain controller is greater than a predetermined minimum does the processor signal the component signal gain controllers that are not the specific component level controller the decrease in gain level.

11. The signal controller of claim 10, wherein when the processor determines to decrease the gain levels of the component signals that are not the specific component signals, the processor signals an increase in gain to the composite signal gain controller.

12. The signal controller of claim 7, when the sum of the peak power levels of the component signals is less than a first predetermined maximum and the power level specifier indicates a decrease in relative power, the processor signals each one of the component signal gain controllers that are not the specific component signal gain controller to increase the gain of the component signal transmitted therefrom, and when the sum is greater than or equal to the first maximum and the power level specifier indicates an decrease in relative power, the processor signals the specific component signal gain controller to decrease the gain of the specific component signal transmitted therefrom.

13. The signal controller of claim 12, wherein the processor only signals the specific component signal gain controller to decrease the gain level when the peak power level of the specific component signal is greater than a first predetermined minimum.

14. The signal controller of claim 12, wherein only when the peak power level of each component signal transmitted from the signal gain controllers that are not the specific signal gain controller is less than a predetermined second maximum does the processor signal the component signal gain controllers that are not the specific component level controller to increase gain.

15. The signal controller of claim 14, wherein when the processor determines to increase the gain levels of the component signals that are not the specific component signals, the processor signals a decrease in gain to the composite signal gain controller.

16. A signal controller for an apparatus that receives a plurality of digital input signals and transmits a single analog signal, the signal controller comprising:
a plurality of component signal gain controllers, each component signal gain controller adapted to transmit a component signal at a predetermined peak power level;
a signal adder in communication with the plurality of component signal gain controllers adapted to receive a plurality of component signals transmitted from the plurality of component signal gain controllers and transmit a composite signal having the plurality of component signals included therein;
a composite signal gain controller in communication with the adder adapted to receive the composite signal and transmit the composite signal at a predetermined peak power level;
a processor in communication with the plurality of component signal gain controllers and the composite signal gain controller adapted to receive a relative gain level specifier and responsive thereto selectively change at least one gain level of the component signals transmitted from the plurality of component signal gain controllers while maintaining the peak power level of the composite signal transmitted from the signal adder beneath a predetermined maximum power level.

17. The signal controller of claim 16, wherein the processor receives a controller specifier that identifies a specific component signal gain controller of the plurality of component signal gain controllers and responsive to the relative gain level specifier indicating an increase in gain, the processor determines whether a gain setting for the specific component signal gain controller is equal to a predetermined maximum, and if not, the processor signals an increase of gain setting to the specific component signal gain controller.

18. The signal controller of claim 17, wherein the processor determines whether the peak power level of the composite signal transmitted from the adder is less than a second predetermined maximum, and the processor only signals the increase of gain setting to the specific component signal gain controller responsive to the peak power level of the composite signal transmitted from the adder being less than the second predetermined maximum.

19. The signal controller of claim 17, wherein responsive to the processor determining the gain setting of the specific component signal gain controller is equal to the predetermined maximum, the processor determines whether each of the other component signal gain controllers has a gain settings that is greater than a predetermined minimum, and responsive to the gain setting for each of the other component signal gain controllers being greater than the predetermined minimum, the processor signals a decrease of gain setting to each of the other component signal gain controllers.

20. The signal controller of claim 19, wherein the processor determines whether a gain setting of the composite signal gain controller is less than a predetermined second maximum, and the processor signals a second increase of gain setting to the composite signal gain controller and signals the decrease of gain level to each of the other component signal gain controllers, wherein the processor only signals the second increase of gain setting and the decrease of gain setting responsive to both the gain setting of the composite signal gain controller being less than the predetermined second maximum and the gain setting for each of the other component signal gain controllers being greater than the predetermined minimum.

21. The signal controller of claim 20, wherein responsive to the processor signaling the decrease gain setting to each of the other component signal gain controllers and the second increase of gain setting to the composite signal gain controller, the power level of the specific component signal carried in the composite signal is increased and the power levels of the other component signals carried in the composite signal are essentially unchanged.

22. The signal controller of claim 16, wherein the processor receives a controller specifier that identifies a specific component signal gain controller of the plurality of component signal gain controllers and responsive to the relative gain level specifier indicating a decrease in gain, the processor determines whether each of the other component signal gain controllers has a gain settings that is less than a predetermined maximum, and responsive to the gain setting for each of the other component signal gain controllers being less than the predetermined maximum, the processor signals an increase of gain setting to each of the other component signal gain controllers.

23. The signal controller of claim 22, wherein the processor determines whether the peak power level of the composite signal transmitted from the adder is less than a second predetermined maximum, and the processor only signals the increase of gain setting to the other component signal gain controllers responsive to the peak power level of the composite signal transmitted from the adder being less than the second predetermined maximum.

24. The signal controller of claim 22, wherein the processor determines whether a gain setting for the composite signal gain controller is greater than a predetermined minimum, and responsive to both the gain setting for the composite signal gain controller being greater than the predetermined minimum and each of the gain settings for each of the other component signal gain controllers being less than the predetermined maximum, the processor signals a decrease of gain setting to the composite signal gain controller.

25. The signal controller of claim 24, wherein responsive to the processor signaling the increase gain setting to each of the other component signal gain controllers and the decrease of gain setting to the composite signal gain controller, the power level of the specific component signal carried in the composite signal is decreased and the power levels of the other component signals carried in the composite signal are essentially unchanged.

26. The signal controller of claim 22, wherein responsive to the processor determining that at least one gain setting for the other component signal gain controllers is equal to the predetermined maximum, the processor determines whether a gain setting of the specific component signal gain controller is greater than a predetermined minimum, and responsive to the gain setting for the specific component signal gain controller being greater than the predetermined minimum, the processor signals a decrease of gain setting to the specific component signal gain controller.

27. The signal controller of claim 16, wherein the processor receives from a user the relative gain level specifier and a controller specifier, which identifies a specific component signal gain controller of the plurality of component signal gain controllers, and the relative gain level specifier indicates an increase or decrease in the relative power levels between at least two of the component signals transmitted from the plurality of component signal gain controllers.

28. A method for transmitting a composite signal at a desired power level, wherein the composite signal includes multiple component signals, the method comprising:
transmitting a composite signal carrying a plurality of component signals therein;
receiving a relative power level indicator that indicates a change in relative power between a specific component signal and the other component signals of the plurality of component signals, wherein the change is either to increase or decrease the relative power difference between the specific component signal and the other component signals; and
selectively changing the power level of at least one component signal of the plurality of component signals according to the relative power level indicator, wherein responsive to the relative power level indicating an increase in the relative power difference, the power level of the specific component signal carried by the composite signal is increased relative to the power levels of the other component signals carried by the composite signal, and wherein responsive to the relative power level indicating a decrease in the relative power difference, the power level of the specific component signal carried by the composite signal is decreased relative to the power levels of the other component signals carried by the composite signal,.

29. The method of claim 28, further including the steps of:
transmitting each component signal of the plurality of component signals from a separate component signal controller;
adding each component signal transmitted from the component signal controllers into a single composite signal, wherein each component signal is transmitted at a unique frequency;
determining a gain setting for the composite signal; and
transmitting the analog signal from a composite signal controller, wherein the composite signal controller uses the gain setting for the composite signal to control the gain of the analog signal transmitted therefrom.

30. The method of claim 29, further including the step of:
receiving from a user a signal controller identifier that identifies a specific component signal controller, wherein the specific component signal controller transmits the specific component signal therefrom.

31. The method of claim 30, wherein the user supplies the relative power level indicator.

32. The method of claim 29, responsive to the relative power indicator indicating an increase in the relative power level, further including the step of:
increasing a component gain setting from a first value to a second value for the specific component signal controller when the first value is less than a predetermined first maximum, wherein the specific signal controller increases the power level of the component signal transmitted therefrom according to the new component gain setting.

33. The method of claim 32, prior to the step of increasing the component gain setting, further including the steps of:
determining whether both the gain setting for the specific component signal controller is equal to the first maximum and the gain setting for the composite signal gain controller is less than a second predetermined maximum, and if so,
determining whether the gain setting for each component signal controller that is not the specific signal controller is greater than a predetermined minimum, and if so,
increasing the relative power level between the specific component signal and the other component signals by the act of decreasing the gain setting for each component signal controller that is not the specific component signal controller from a first value to a second value, wherein each component signal controller having a new gain setting reduces the power level of the component signal transmitted therefrom according to its new component gain setting.

34. The method of claim 33, further including the step of:
increasing the gain setting for the composite signal gain controller from a first value to a second value, wherein the composite signal controller increases the gain of the composite signal transmitted therefrom according to its new gain setting.

35. The method of claim 34, wherein prior to the steps of increasing the relative power level and increasing the gain setting for the composite signal gain controller, each component signal that is not the specific component signal in the composite signal transmitted from the composite signal controller is at a first power level, and after the steps of increasing the relative power level and increasing the gain setting for the composite signal gain controller, the power level of each component signal that is not the specific component signal in the composite signal transmitted from the composite signal gain controller is substantially the same as the first power level.

36. The method of claim 29, responsive to the relative power indicator indicating a decrease in the relative power level, further including the steps of:
decreasing a component gain setting from a first value to a second value for the specific component signal controller when the first value is greater than a predetermined first minimum, wherein the specific signal controller decreases the power level of the component signal transmitted therefrom according to the new component gain setting.

37. The method of claim 36, prior to the step of decreasing the component gain setting, further including the steps of:
determining whether both the gain setting for the specific component signal controller is equal to the first minimum and the gain setting for the composite signal gain controller is greater than a second predetermined minimum, and if so,
determining whether the gain setting for each component signal controller that is not the specific signal controller is less than a predetermined maximum, and if so,
decreasing the relative power level between the specific component signal and the other component signals by the act of increasing the gain setting for each component signal controller that is not the specific signal controller from a first value to a second value, wherein each component signal controller having a new gain setting increases the power level of the component signal transmitted therefrom according to its new component gain setting.

38. The method of claim 37, further including the step of:
decreasing the gain setting for the composite signal gain controller from a first value to a second value, wherein the composite signal controller decreases the gain of the composite signal transmitted therefrom according to its new gain setting.

39. The method of claim 38, wherein prior to the steps of decreasing the relative power level and decreasing the gain setting for the composite signal gain controller, each component signal that is not the specific component signal in the composite signal transmitted from the composite signal controller is at a first power level, and after the steps of decreasing the relative power level and decreasing the gain setting for the composite signal gain controller, the power level of each component signal that is not the specific component signal in the composite signal transmitted from the composite signal gain controller is substantially the same as the first power level.

40. A method for transmitting a composite signal, the method comprising:
receiving a composite signal having multiple component signal carried therein, wherein each component signal is carried at a different frequency;
selecting a specific component signal of the composite signal;
receiving a power level indicator that indicates an increase or decrease in the relative power level between the specific component signal and other component signals of the composite signal; and
selectively adjusting the relative power between the specific component signal and other component signals of the composite signal using the relative power level indicator.
